(19) United States
(12) Patent Application Publication
(10) Pub. No.: US 2010/0043025 A1
(43) Pub. Date: Feb. 18, 2010

(54) PROGRAM GUIDE DISPLAY APPARATUS

(75) Inventors: Takanobu NISHIGAI, Yokohama-shi (JP); Yoshiyuki Ban, Yokohama-shi (JP); Satoshi Kawaji, Yokohama-shi (JP); Makoto Chishima, Yokohama-shi (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Kyoto (JP)

(21) Appl. No.: 12/474,197

(22) Filed: May 28, 2009

(30) Foreign Application Priority Data
May 29, 2008 (JP) 2008-140778

(51) Int. Cl. H04N 5/445

(52) U.S. Cl. 725/40; 725/39; 725/58

(57) ABSTRACT

In order to provide a program guide display apparatus that improves the user convenience by performing identification display to a program guide according to a reception state of the broadcast, the program guide display apparatus of the present invention comprises a 1seg reception unit 203 and a M-FLO reception unit 211 for receiving a program by selecting a selected channel, a display unit 306 for displaying a program guide that shows each program of each channel and a control unit 301 for controlling so that identification display corresponding to reception state of the 1seg reception unit 203 and the M-FLO reception unit 211 is performed, and the control unit 301 controls so that identification display corresponding to the reception state of the 1seg reception unit 203 and the M-FLO reception unit 211 is performed per channel or per program.

### CROSS REFERENCE TO RELATED APPLICATION

This application claims priority to and the benefit of Japan Patent Application No. 2008-140778 filed on May 29, 2008, the entire contents of which are incorporated herein by reference.

### TECHNICAL HELD

The present invention relates to a program guide display apparatus for performing an identification display corresponding to a reception state of broadcast.

### BACKGROUND ART

In recent years, with respect to mobile terminals, there are various broadcast standards such as broadcast of ISDB-T (digital terrestrial broadcasting) for mobiles (e.g. 1seg (one-segment) digital TV), MediaFLO (Forward Link Only proposed by Qualcomm Inc., USA), which is a broadcast standard for mobiles, and DVB-H (European Telecommunications Standards Institute (ETSI)). Due to diversification of such broadcast standards, increase in multi-channel broadcasting is expected also in the mobile field. With increase in such multi-channel, it is expected that the number of channels will reach, for example, 150˜200. However, it is not easy to find a desired program among the programs broadcasted by such many channels. In other words, if a user checks each program being actually broadcasted on each channel in order to find a desired program, the user feels troublesome when the number of channels is large as mentioned above, setting aside the case where the number of channels is small. Consequently, at present, broadcast of EPG (Electronic Program Guide) or the like for guiding programs is performed to allow the user to identify the contents of programs and further to select a program easily.

A conventional art that improves the user convenience by adding a new twist to the display method of EPG (Electronic Program Guide) has been proposed. According to the conventional art described in Japanese Unexamined Patent Application Publication No. 2007-124534, improvement of the user convenience is ensured by notifying a user of availability of program recording on a remaining space of an HDD at the time of reservation of a program to be recorded, based on the remaining space of an HDD, by displaying a differently-colored program guide when the remaining space of the HDD becomes small in an HDD (Hard Disk Drive) recorder.

### SUMMARY OF INVENTION

### Technical Problem

When assuming that broadcast programs are viewed by mobile terminals such as cellular phones, according to a change in the propagation environment of radio waves as a mobile terminal moves, the situation may arise where reception at a certain frequency band is possible while at other frequency band reception is possible but the reception is performed under a deteriorated reception state of radio waves. However, the above-mentioned conventional art discloses only the control that allows notification of availability of recording based on a remaining space of an HDD, and does not disclose any solution to “a problem where the reception state of broadcast waves changes due to a change of the propagation environment of radio waves”. In other words, according to the above-mentioned conventional art, no change is made to a display of program guide even in the case where a broadcast program cannot be viewed because it is impossible to receive broadcast waves. Therefore, depending on the reception state of radio waves, there is a possibility that an image is deteriorated due to generation of block noise and reduction in the number of frames even if the selected frequency band (channel) can be viewed. And thus, there was a problem that a user feels uncomfortable when the user selects a channel whose image has been deteriorated.

An object of the present invention is to provide a technology (program guide display apparatus) that improves the user convenience by performing an identification display to a program guide according to a reception state of broadcast.

### Solution to Problem

A program guide display apparatus of claim 1 of the present invention in order to achieve the above object, comprising: a reception unit for receiving a program by selecting a selected channel; a display unit for displaying a program guide that shows each program of each channel; and a control unit for controlling so that an identification display corresponding to a reception state of the reception unit is performed with respect to the program guide displayed by the display unit.

A program guide display apparatus according to claim 2 of the present invention, wherein the control unit controls so that the identification display corresponding to the reception state of the reception unit is performed per channel or per program.

A program guide display apparatus according to claim 3 of the present invention, comprising a recording unit for recording, when a program is selected from the program guide displayed by the display unit, the selected program.

A program guide display apparatus according to claim 4 of the present invention, wherein the control unit controls so that, based on a reception state of the reception unit, with respect to a program that cannot be viewed, selection of the program is cancelled.

A program guide display apparatus according to claim 5 of the present invention, comprising: a recording unit for recording, when a program is selected from the program guide displayed by the display unit, the selected program; and a reservation unit for making a recording reservation, when a program is selected from the program guide displayed by the display unit, of the selected program, wherein the control unit controls so that, based on a reception state of the reception unit, with respect to a program that may not be viewed or a program that can be viewed but has a possibility that an image quality is deteriorated, a warning message on recording is displayed when the program is selected.

A program guide display apparatus according to claim 6 of the present invention, wherein the reception unit comprises a first reception unit for receiving a program by selecting a channel of a first frequency band and a second reception unit for receiving a program by selecting a channel of a second frequency band, and the control unit controls so that the identification display corresponding to a reception state of each the first reception unit and the second reception unit is performed.

A program guide display apparatus according to claim 7 of the present invention, wherein the control unit controls so that the identification display is performed based on an image quality corresponding to a reception state of the reception unit.

### Advantageous Effects on Invention

According to the present invention, for a program guide that shows each program of each channel displayed by a display unit, since an identification display is performed corresponding to a reception state of a reception unit, a user who sees this identification display can know whether viewing is possible or not, whether there is a possibility that an image of a program is deteriorated or not or the like in advance without selecting a channel. Thus the user convenience is improved.

### BRIEF DESCRIPTION OF DRAWINGS

FIG. 1 is a function block diagram showing a configuration of the first embodiment of the program guide display apparatus of the present invention;

FIGS. 2(a) and (b) are diagrams illustrating an image quality level table used by the program guide display apparatus of the present invention;

FIG. 3 is a diagram exemplifying an image quality level determination table for 1seg broadcasting used by the program guide display apparatus of the present invention;

FIG. 4 is a diagram exemplifying an image quality level determination table for M-FLO broadcasting used by the program guide display apparatus of the present invention;

FIG. 5 is a table illustrating a relationship between image quality level and possibility of viewing of the program guide display apparatus of the present invention;

FIG. 6 is a function block diagram showing another configuration of the first embodiment of the program guide display apparatus of the present invention;

FIG. 7 is a flow chart showing a main program of EPG (Electronic Program Guide) display at the time of program viewing for the program guide display apparatus of the present invention;

FIG. 8 is a flow chart showing an image quality level determination program for preparing and updating an image quality level table used for the EPG (Electronic Program Guide) display at the time of program viewing for the program guide display apparatus of the present invention;

FIG. 9 is a flow chart showing the differently-colored EPG (Electronic Program Guide) display program at the time of program viewing for the program guide display apparatus of the present invention;

FIG. 10(a) is a table showing an EPG display example in the case where a differently-colored display is performed for the program guide display apparatus of the present invention, and (b) is a table showing an EPG display example in the case where a differently-colored display is not performed for the program guide display apparatus of the present invention;

FIG. 11 is a flow chart showing a main program of EPG (Electronic Program Guide) display at the time of program recording reservation for the program guide display apparatus of the present invention;

FIG. 12 is a diagram exemplifying a warning message per image quality level displayed on a standby screen at the time of program recording reservation for the program guide display apparatus of the present invention;

FIG. 13(a) is a diagram showing a display example of the standby screen of the program guide display apparatus of the present invention under a normal state, and (b) is a diagram showing an example of warning message displayed on a standby screen at the time of program recording reservation for the program guide display apparatus of the present invention; and

FIG. 14 is a diagram exemplifying classification of channels 1˜12 of the program guide display apparatus of the present invention.

### DESCRIPTION OF THE NUMBERS

100. Program guide display apparatus
101. CDMA antenna
102. CDMA transmission/reception unit
103. CDMA demodulation unit
201. Broadcast reception antenna
202. 1seg tuner module
203. 1seg reception unit
204. 1seg demodulation unit
205. 1seg reception level acquisition unit
210. M-FLO tuner module
211. M-FLO reception unit
212. M-FLO demodulation unit
213. M-FLO reception level acquisition unit
301. Control unit
302. Key input unit
303. Sounder unit
304. Voice input unit
305. Power supply
306. Display unit
307. Image driver unit
308. Program guide color display unit
309. Memory unit
310. Image quality level determination unit

### BEST MODE FOR CARRYING OUT THE INVENTION

Hereinafter, a preferred embodiment of the present invention will now be described with reference to the accompanying drawings.

### First Embodiment

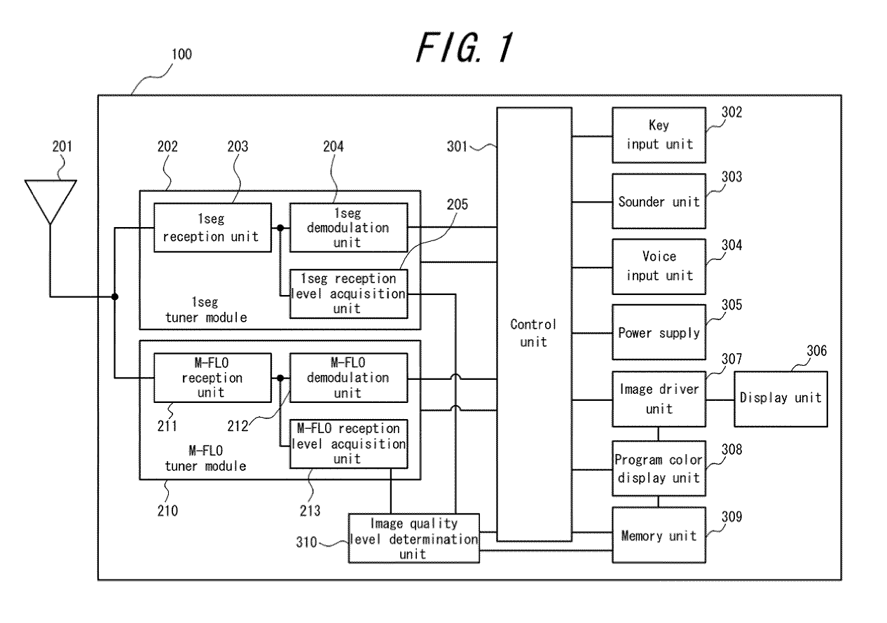

FIG. 1 is a function block diagram showing a configuration of the first embodiment of the program guide display apparatus of the present invention. A program guide display apparatus 100 of the present invention is constituted as a portable terminal capable of receiving a plurality of broadcast systems, and in the case of a configuration exemplified in FIG. 1, includes two tuner modules, which are a 1seg tuner module 202 capable of receiving and demodulating a 1seg (one-segment) digital broadcasting, which is a first broadcast system, and a M-FLO tuner module 210 capable of receiving and demodulating a MediaFLO (hereinafter referred to as M-FLO) broadcasting, which is a second broadcast system.

The 1seg tuner module 202 includes a 1seg reception unit 203 for receiving 1seg broadcasting through a broadcast reception antenna 201, a 1seg demodulation unit 204 for demodulating a 1seg broadcast signal received by the 1seg reception unit 203 and a 1seg reception level acquisition unit 205 for acquiring RSSI and C/N of a 1seg broadcast signal. In addition, the M-FLO tuner module 210 includes a M-FLO reception unit 211 for receiving M-FLO broadcasting through the broadcast reception antenna 201, a M-FLO demodulation unit 212 for demodulating a M-FLO broadcast signal received by the M-FLO reception unit 211 and a M-FLO reception level acquisition unit 213 for acquiring RSSI and C/N of a M-FLO broadcast signal. Further, the broadcast reception antenna 201 is shared for 1seg broadcasting and M-FLO broadcasting.

The program guide display apparatus 100 of the present embodiment further includes an image quality level determination unit 310 for determining an image quality level that can be received based on a reception level (RSSI and C/N) of a 1seg broadcast signal acquired by the 1seg reception level acquisition unit 205 and a reception level (RSSI and C/N) of a M-FLO broadcast signal acquired by the M-FLO reception level acquisition unit 213, a control unit 301 for performing various processing based on a demodulated 1seg broadcast signal, a demodulated M-FLO broadcast signal and a determining result of the image quality level determination unit 310, and a program guide color display unit 308 for performing differently-colored display of an EPG (Electronic Program Guide) as an identification display of a program guide. Further the program guide display apparatus 100 also includes a key input unit 302, a sounder unit 303, a voice input unit 304, a power supply 305, a display unit 306, an image driver unit 307 and a memory unit 309.

The above-mentioned 1seg reception unit 203 is a reception unit for receiving a program by selecting a selected channel and corresponds to a first reception unit for receiving a program by selecting a channel of a first frequency band. The above-mentioned M-FLO reception unit 211 is a reception unit for receiving a program by selecting a selected channel and corresponds to a second reception unit for receiving a program by selecting a channel of a second frequency band. The above-mentioned 1seg reception unit 203 and the M-FLO reception unit 211 have a function, when a program is selected from a program guide displayed by the display unit 306, of receiving the program by selecting a channel corresponding to the selected program.

The above-mentioned display unit 306 corresponds to a display unit that displays a program guide that shows each program of each channel.

The above-mentioned control unit 301 corresponds to, with respect to the program guide displayed by the display unit, a control unit that controls so that the identification display corresponding to a reception state of the reception unit is performed, and performs the identification display corresponding to a reception state of the reception unit, for example, per channel or per program. The above-mentioned control unit 301 has functions, for a program that cannot be viewed, of controlling so that selection of the program is cancelled based on a reception state of the reception unit, for a program which may not be viewed or a program which can be viewed but there is a possibility that the image quality is deteriorated, of controlling so that a warning on recording is displayed when selecting the program based on a reception state of the reception unit, of controlling so that the identification display is performed corresponding to a reception state of each of the above-mentioned first and second reception units, and of controlling so that the identification display is performed based on an image quality corresponding to a reception state of the reception unit. “For a program that cannot be viewed, selection of the program is cancelled” means “in the case where a user performs an operation of selecting a program that cannot be viewed from the program guide, behavior of ignoring the operation without responding to the operation” is performed, “in the case where a user performs the operation of selecting a program that cannot be viewed from the program guide, behavior of displaying on the display unit 306 a message indicating that the operation is cancelled without responding to the operation” is performed and the like. Further, when a program is selected from the program guide displayed by the display unit 306, the control unit 301 and the memory unit 309 correspond to a recording unit that records the selected program, and when a program is selected from the program guide displayed by the display unit 306, correspond to a reservation unit that makes a recording reservation of the selected program as well.

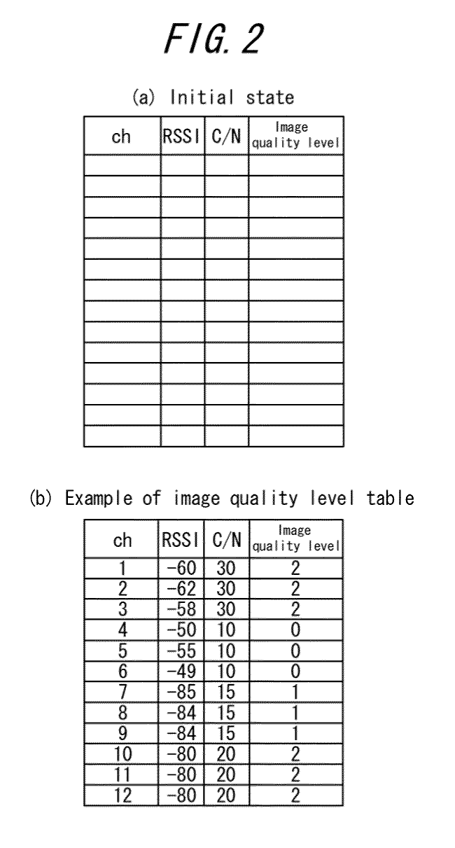

In the above-mentioned memory unit 309, the image quality level tables as shown in FIGS. 2(a) and (b) are stored. FIG. 2(a) shows an initial state (a state where no data exists) of the image quality level table and FIG. 2(b) shows an example of the image quality level table in the state where data is stored. This image quality level table is a table for storing a channel (ch) that could be received, a reception level of a broadcast signal (RSSI and C/N) of the channel (ch) and an image quality level determined by the image quality level determination unit 310. The example of the image quality level table in FIG. 2(b) shows a state where RSSI values, C/N values and image quality level values (0, 1 or 2 for 1seg broadcasting, and 0, 1, 2 or 3 for M-FLO broadcasting) are stored with respect to each of channels 1˜12.

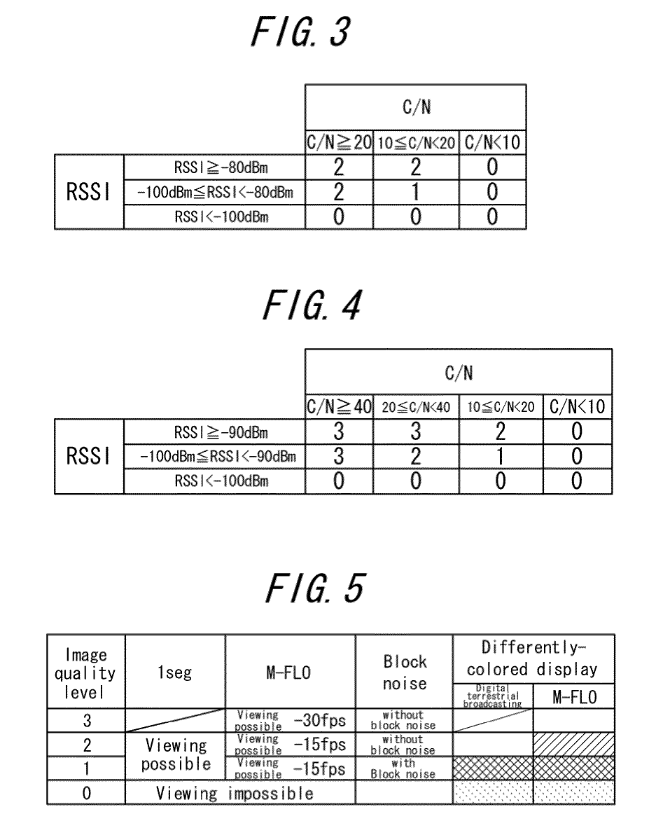

Further, in the above-mentioned memory unit 309, an image quality level determination table for 1seg broadcasting as shown in FIG. 3 and an image quality level determination table for M-FLO broadcasting as shown in FIG. 4 are stored. The image quality level determination table for 1seg broadcasting in FIG. 3 shows a correlation between the reception level of a broadcast signal (RSSI and C/N) and the image quality level. Here, RSSI is divided into 3 sections such as “RSSI≧−80 dBm”, “−100 dBm≦RSSI<−80 dBm”, and “RSSI<−100 dBm” and C/N is divided into three sections such as “C/N≧20”, “10≦C/N<20” and “C/N<10” as well. Then, the values of the image quality levels (0, 1 or 2) as shown in the figure are set with respect to each of 3×3=9 sections. In addition, the image quality level determination table for M-FLO broadcasting in FIG. 4 shows a correlation between the reception level of a broadcast signal (RSSI and C/N) and the image quality level. In which RSSI is divided into 3 sections such as “RSSI≧−90 dBm”, “−100 dBm≦RSSI<−90 dBm”, and “RSSI<−100 dBm” and C/N is divided into four sections such as “C/N≧40”, “20≦C/N<40”, “10≦C/N<20 and “C/N<10” as well. Then the values of the image quality level (0, 1, 2 or 3) as shown in the figure are set with respect to each of 3×4=12 sections.

FIG. 5 is a table illustrating a relationship between the image quality level and the possibility of viewing of the program guide display apparatus of the present invention. In the case of 1seg broadcasting, viewing is impossible when the image quality level is 0, viewing is possible (with block noise) when the image quality level is 1, and viewing is possible (no block noise) when the image quality level is 2. Thus, viewing with a higher image quality is possible as the image quality level becomes high. In addition, in the case of M-FLO broadcasting, viewing is impossible when the image quality level is 0, viewing is possible (15 fps, with block noise) when the image quality level is 1, viewing is possible (15 fps, no block noise) when the image quality level is 2 and viewing is possible (30 fps, no block noise) when the image quality level is 3. Thus, viewing with a higher image quality is possible as the image quality level becomes high. Further, since viewing is impossible when the image quality level is 0 with respect to 1seg broadcasting and M-FLO broadcasting, when the user performs the operation of selecting a program whose image quality level is 0 from a program guide, the operation is cancelled as mentioned above.

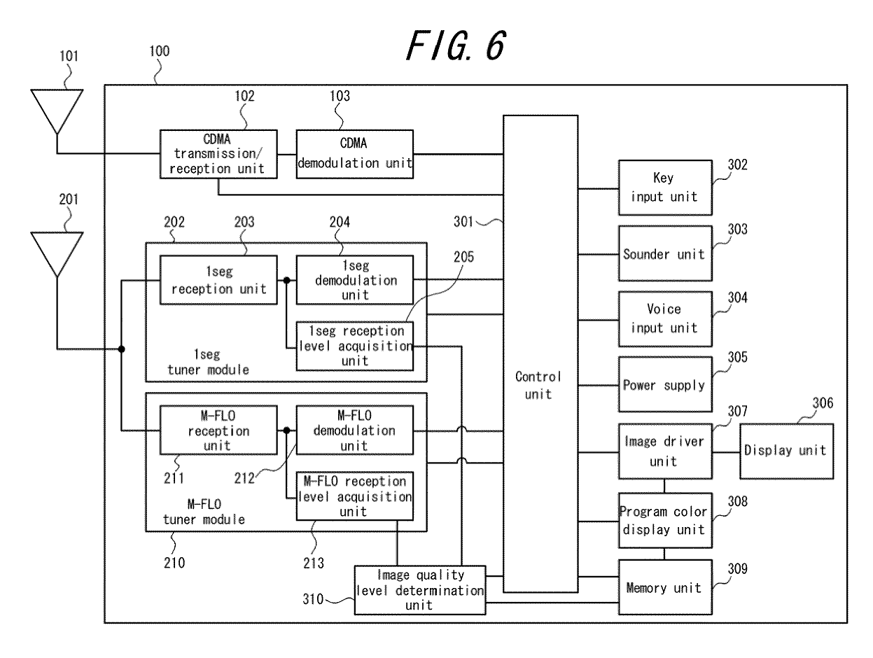

FIG. 6 is a function block diagram showing another configuration of the first embodiment of the program guide display apparatus of the present invention. The program guide display apparatus 100 having a configuration of FIG. 6, relative to the program guide display apparatus having a configuration of FIG. 1, additionally includes a CDMA antenna 101, a CDMA transmission/reception unit 102 and a CDMA demodulation unit 103, and an output terminal of the CDMA demodulation unit 103 is connected to the control unit 301 in order to perform wireless communication. Other portions are configured equally to the program guide display apparatus having a configuration of FIG. 1. It should be noted that additional communication means is not limited to CDMA, and GSM, W-CDMA, LTE, WLAN, WiMax or the like may be used. In addition, although not shown herein, it is possible to provide an antenna for 1seg broadcasting and an antenna for M-FLO broadcasting separately. Moreover, it is also possible to integrate a 1seg tuner module and a M-FLO tuner module or to provide a configuration including either a 1seg tuner module or a M-FLO tuner module.

Next, display behavior of the EPG (Electronic Program Guide) of the program guide display apparatus of the first embodiment, at the time of viewing and at the time of recording, is separately described.

### [Display Method of EPG (Electronic Program Guide) at the Time of Viewing]

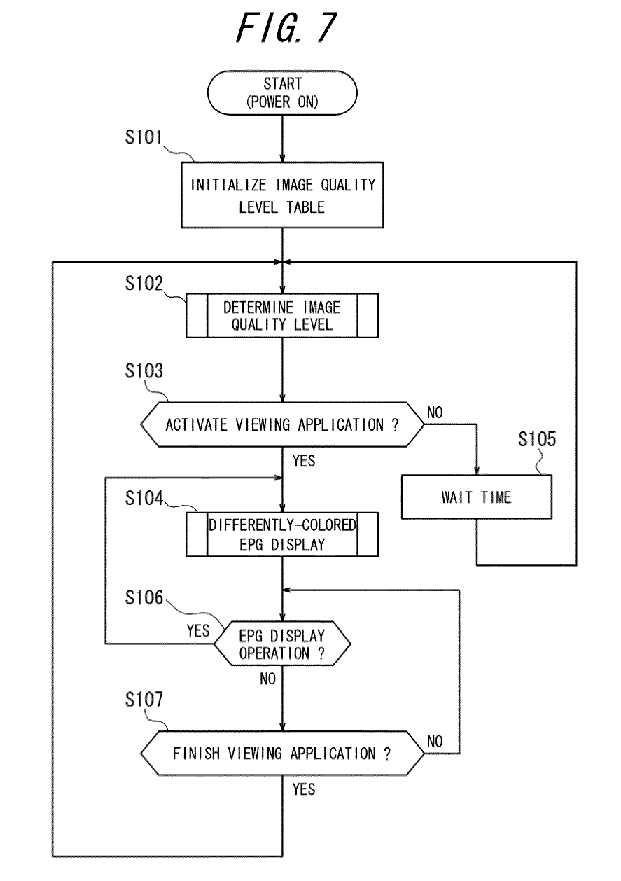

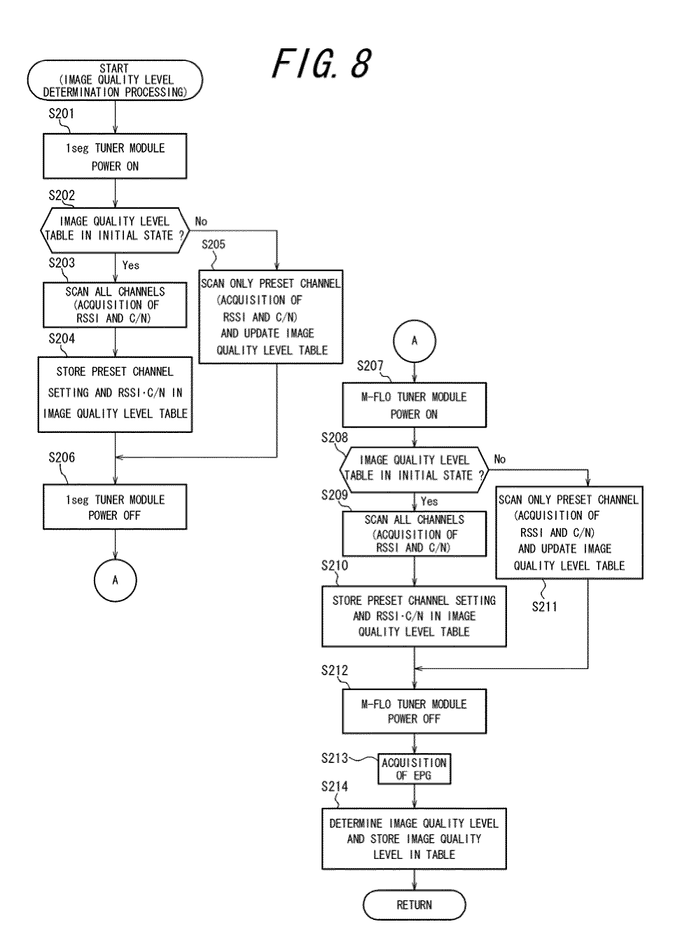

FIG. 7 is a flow chart showing a main program of EPG (Electronic Program Guide) display at the time of viewing for the program guide display apparatus of the present invention. This main program of EPG display in FIG. 7 is activated by turning on (ON) the power of the program guide display apparatus 100. At first, in step S101, an image quality level table stored in the memory unit 309 is initiated. For example, in the case where the image quality level table shown in FIG. 2(b) has been stored in the memory unit 309, the state shown in FIG. 2(a) is obtained after initialization. In the next step S102, based on the image quality level determination program in FIG. 8 described hereinafter, determination of the image quality level and update of the image quality level table based on the determination results are performed.

FIG. 8 is a flow chart of the program guide display apparatus of the present invention showing the image quality level determination program for preparing and updating the image quality level table used for the EPG (Electronic Program Guide) display at the time of viewing. At first, in step S201, the power of the 1seg tuner module 202 is turned on (ON). In the next step S202, whether the image quality level table is in an initial state (for example, no data is stored as shown in FIG. 2(a)) or not is checked, then when it is in the initial state, the process moves to step S203, and when it is not in the initial state (for example, a predetermined data is stored as shown in FIG. 2(b)), the process moves to step S205. In step S203 to be proceeded in the case of an initial processing or the like, all of the channels are scanned and RSSI and C/N of the channels that could be received are acquired. In the next step S204, the preset channel setting and the acquired RSSI and C/N are stored in the image quality level table. On the other hand, in step S205 to be proceeded in the case of after the second time processing or the like, only the preset channels (in the case of the image quality level table in FIG. 2(b), the channels for 1seg broadcasting among the channels 1˜12) are scanned, RSSI and C/N of the preset channels are acquired and the image quality level table is updated. In step S206 following steps S204 and S205, the power of the 1seg tuner module 202 is turned off (OFF). Thus, unnecessary power consumption of the 1seg tuner module can be reduced.

In the next step S207, the power of the M-FLO tuner module 210 is turned on (ON). In the next step S208, whether the image quality level table is in the initial state (for example, no data is stored as shown in FIG. 2(a)) or not is checked, then when it is in the initial state, the process moves to S209, and when it is not in the initial state (for example, a predetermined data is stored as shown in FIG. 2(b)), the process moves to S211. In step S209 to be proceeded in the case of the initial processing or the like, all of the channels are scanned and RSSI and C/N of the channels that could be received are acquired. In the next step S210, the preset channel setting and the acquired RSSI and C/N are stored in the image quality level table. On the other hand, in step S211 to be proceeded in the case of after the second time processing or the like, only the preset channels (in the case of the image quality level table in FIG. 2(b), the channels for M-FLO broadcasting among the channels 1˜12) are scanned, RSSI and C/N of the preset channels are acquired and the image quality level table is updated. In step S212 following steps S210 and S211, the power of the M-FLO tuner module 210 is turned off (OFF). Thus, unnecessary power consumption of the M-FLO tuner module can be reduced.

After that, in step S213, an EPG is acquired and it is stored in the memory unit 309. The EPG can be acquired from the 1seg broadcast program information. However, in the case of the program guide display apparatus shown in FIG. 6, the communication means of CDMA (a CDMA antenna 101, a CDMA transmission/reception unit 102 and a CDMA demodulation unit 103) may be used for the acquisition. In step S214 to be proceeded after acquiring the EPG, in the image quality level determination unit 310, the image quality level of respective channels of 1seg broadcasting and M-FLO broadcasting is determined by comparing the measurement results of RSSI and C/N of the image quality level table with the image quality level determination table for 1seg broadcasting shown in FIG. 3 and the image quality level determination table for M-FLO broadcasting shown in FIG. 4. Then the image quality level table is completed. The completed image quality level table is, for example, as shown in FIG. 2(b). In this manner, by completing preparation of the image quality level table and acquisition of the EPG before activating a viewing application, uncomfortable wait time for measuring an image quality does not occur when the user actually activates the viewing application.

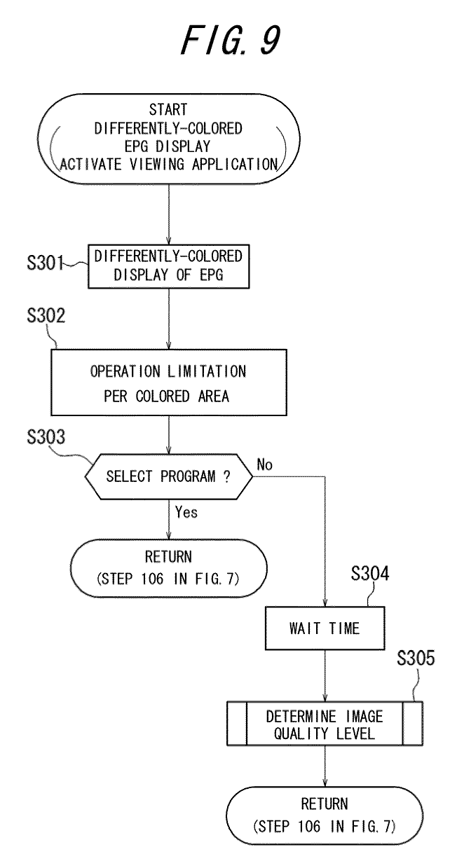

In step S103 to be proceeded after finishing the image quality level determination of step S102 in FIG. 7, whether the viewing application has been activated or not is checked. Then the process moves to step S105 if the viewing application has not been activated. Then after a predetermined wait time, the process returns to the above-mentioned step S102. In the case where the viewing application has been activated and an operation of the EPG display has been performed, the process moves to step S104 and the differently-colored EPG display program is executed shown in FIG. 9.

FIG. 9 is a flow chart of the program guide display apparatus of the present invention showing the differently-colored EPG (Electronic Program Guide) program at the time of viewing. This differently-colored EPG (Electronic Program Guide) display program is activated by performing an operation to program information display such as an EPG after the viewing application is activated. At first, in step S301, by the program guide color display unit 308, a differently-colored EPG (Electronic Program Guide) display is performed by using an image quality level table (for example, the image quality level table shown in FIG. 2(b)) that exists on a memory. At this time, the image quality level and the image quality have a relationship, for example, as shown in FIG. 5. In other words, in the case of 1seg broadcasting, at the image quality level 2, viewing is possible without problem. However, at the image quality level 1, block noise occurs and at the image quality level 0, radio waves cannot be received and even display is impossible. On the other hand, in the case of M-FLO broadcasting, at the image quality level 3, a high quality (no block noise) image at 30 fps can be viewed. However, at the image quality level 2, only 15 fps image without block noise can be received. Further, at the image quality level 1, only 15 fps image with block noise can be received. Then at the image quality level 0, even display is impossible because radio waves cannot be received.

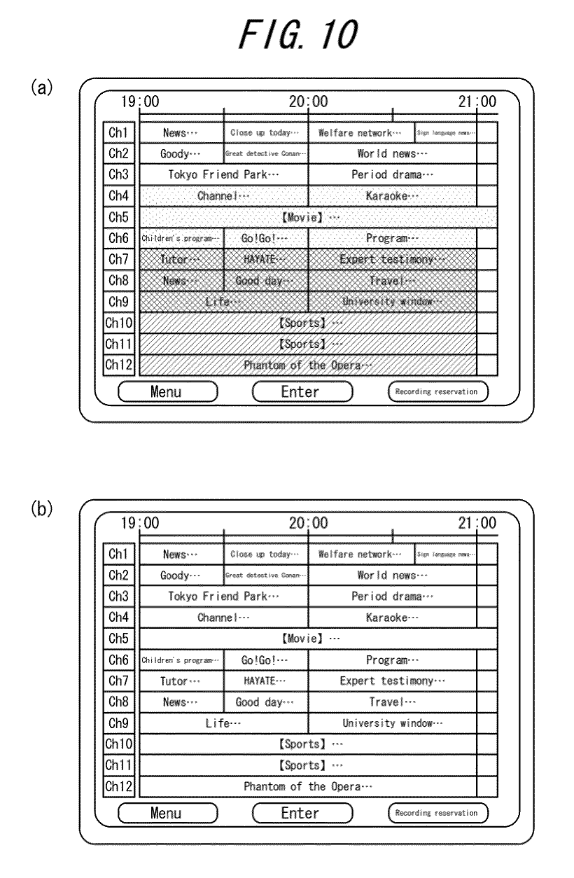

FIG. 10(a) is a table showing an example of an EPG display for the program guide display apparatus of the present invention in the case where the differently-colored EPG display of step S301 in FIG. 9 is performed based on the image quality level table in FIG. 2(b), and FIG. 10(b) is a table showing an example of a normal EPG display in the case where the differently-colored display is not performed for the program guide display apparatus. The differently-colored EPG display that is exemplified in FIG. 10(a) corresponds to the image quality level table in FIG. 2(b). The channels 1˜3 corresponding to the UHF-LOW frequency band of 1seg broadcasting are determined as the image quality level 2 based on the image quality level determination table for 1seg in FIG. 3. Therefore, these channels are displayed without colors (the same display as the normal EPG display). Then the channels 4˜6 corresponding to the UHF-Mid frequency band of 1seg broadcasting are determined as the image quality level 0 based on the image quality level determination table for 1seg in FIG. 3. Therefore, these channels are displayed with the densest color (this display shows that even if a selection is performed, the selection is cancelled, and is indicated with many dots in the example of the figure). The channels 7˜9 corresponding to the UHF-High frequency band of 1seg broadcasting are determined as the image quality level 1 based on the image quality level determination table for 1seg in FIG. 3. Therefore, these channels are displayed with the second densest color (indicated by crossed diagonal lines in the example of the figure). The channels 10˜12 corresponding to the VHF frequency band of M-FLO broadcasting are determined as the image quality level 2 based on the image quality level determination table for M-FLO broadcasting in FIG. 4. Therefore, these channels are displayed with the third densest color (indicated by diagonal lines in the example of the figure). In addition, the example of the differently-colored EPG display in FIG. 10(a) shows a case where the differently-colored EPG display is performed for all of the channels regardless of whether a selection is performed or not. However, the differently-colored EPG display may be performed to at least one channel that was received and selected by the 1seg reception unit 203 or the M-FLO reception unit 211 based on a selection.

In FIG. 9, operation limitation per colored area is performed in the next step S302. With respect to the operation limitation per colored area, for example, conditions of operation limitation are set per colored area such as “for a channel of the image quality level 0, the channel is not selected even if the user performs the selecting operation”, “for a channel of the image quality level 0, which cannot be received, the channel is skipped (selection is not allowed) at the time of selection”. However, when this is applied to a program guide display apparatus having a recording function, since there are some cases where the image quality level at the time of recording may be different from that is determined at the present moment, the above-mentioned channel skip is not set.

The above-mentioned operation limitation of “for a channel of the image quality level 0, the channel is not selected even if the user performs the selecting operation” means “when the user performs the selecting operation of a channel of the image quality level 0, selection of the channel is not performed”. However, the following operation limitations may be included; (1) When the user selects a program of a channel whose image quality level is 0 for viewing from the EPG (Electronic Program Guide) displayed by the display unit 306, since the program is a program that cannot be viewed, the control unit controls so that the selection of the program that cannot be viewed is cancelled based on the reception state (image quality level 0) of the reception unit. (2) When the user selects a program of the image quality level 0, which is being broadcasted, from the EPG (Electronic Program Guide) displayed by the display unit 306 for recording, since the program is a program that cannot be viewed (therefore, it is a program that cannot be recorded), the control unit cancels the recording selection of the program that cannot be viewed based on the reception state (image quality level 0) of the reception unit.

In the next step S303, whether the user who saw the differently-colored EPG display has selected a program on a channel or not is determined. When the user has selected the program (in the case of Yes), the process moves to step S106 of the main program of EPG display in FIG. 7. When the user has not selected the program (in the case of No), the process moves to step S304. In step S304, the process waits for a predetermined time period to pass, then when another channel has not been selected after a predetermined time period, the EPG display is switched off and the process moves to step S305. Then after the image quality level determination program in FIG. 8 is executed and the image quality level table is updated as in the case of step S102 in FIG. 7, the process moves to step S106. In step S106 in FIG. 7, whether the user has performed a display operation of the EPG or not is checked, then S104 is performed when the operation has been performed. In addition, whether the viewing application has been finished or not is checked in step S107, and when the viewing application has been finished, the process returns to step S102 and the image quality level determination program in FIG. 8 is executed again and the image quality level table is updated.

By performing the differently-colored EPG display as mentioned above, the user can actually acquire information such as which channel (program) can be viewed and which channel (program) cannot be viewed or, and in the case where the channel can be viewed, information of whether there is block noise or not is acquired before the user actually views (selects) a channel. Thus, without causing wait time for selecting a channel, the user convenience is improved. In addition, when a channel (program) that cannot be viewed is selected, the selection is cancelled. Therefore, it is possible to prevent the user from feeling uncomfortable or from performing unnecessary channel switching caused by the fact that the user can know that the selected channel cannot be viewed only after selecting the channel. Thus the user convenience is improved. Further, since a plurality of programs broadcasted by each of a plurality of channels are integrally displayed on the display unit 306 as the EPG (Electronic Program Guide) and a desired program can be selected from the EPG (Electronic Program Guide), the user convenience is improved. In addition, in the case where a broadcast that can change the image quality based on RSSI and C/N of a signal to be received, such as MediaFLO, is received, the image quality level can be advised to the user. Thus the user convenience is improved. Moreover, power saving can be realized by lengthening the measurement of RSSI and C/N and by decreasing the number of channels to be measured. On the other hand, search speed of channel (channel selection speed) can be made faster and the differently-colored EPG display can be speeded up by shortening the measurement and measuring all of the target channels.

Display Method of EPG (Electronic Program Guide) at the Time of Recording Reservation]

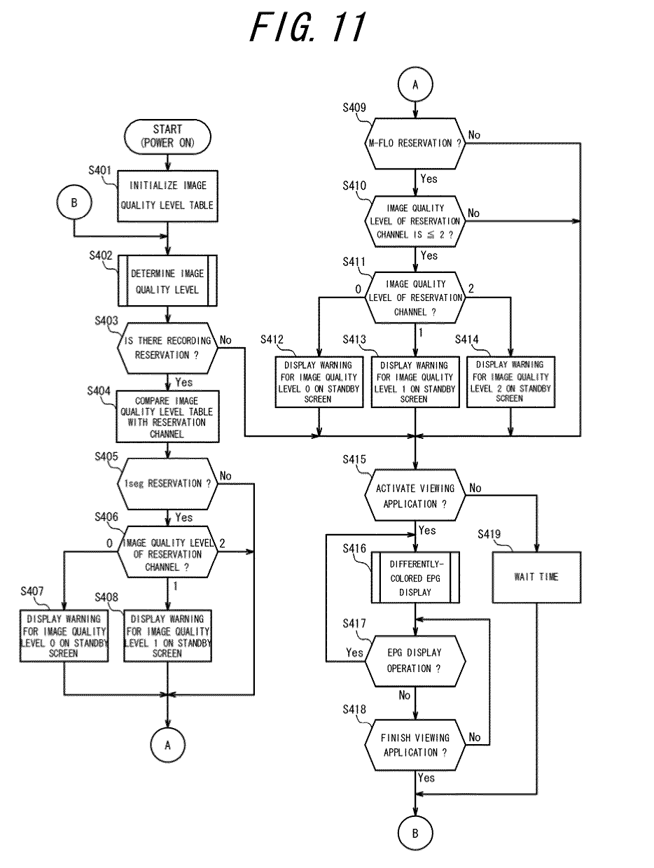

FIG. 11 is a flow chart for the program guide display apparatus of the present invention showing a main program of EPG (Electronic Program Guide) display at the time of program recording reservation. The main program of EPG display in FIG. 11 is activated by turning on (ON) the power of the program guide display apparatus 100. In the following explanation, it is assumed that the user has already made a recording reservation of a certain program. At first, in step S401, the image quality level table stored in the memory unit 309 is initialized. For example, when the image quality level table shown in FIG. 2(b) has been stored in the memory unit 309, the state shown in FIG. 2(a) is obtained after initialization. In the next step S402, the above-mentioned image quality level determination program (including updating of the image quality level table based on the determination result) in FIG. 8 is executed.

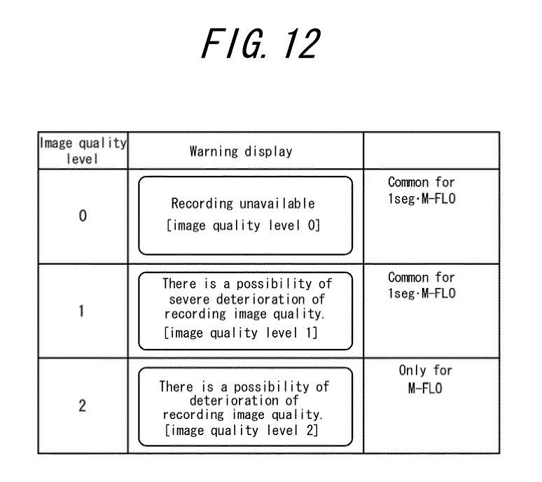

After that, in step S403, whether there is a recording reservation or not in the memory unit 309 is checked. In this case, when there is no recording reservation (in the case of No), the process moves to S415 described hereinafter. Then in steps S415˜S419, the same processing as in the case of steps S103˜S107 in FIG. 7 is performed. If there is a recording reservation in step S403 (in the case of Yes), the process moves to step S404. In step S404, the image quality level table is compared with the reserved channel, and the image quality level of the reserved channel is checked. In the next step S405, whether the recording reservation is a reservation of 1seg broadcasting or not is checked. In this case, when it is a reservation of 1seg broadcasting, the process moves to step S406 and which of 0, 1 or 2 the image quality level of the reserved channel corresponds to is checked. Then if it is not a reservation of 1seg broadcasting, the process immediately moves to step S409 described hereinafter. If the image quality level is 0 according to the check of step S406, the process moves to S407. Then a warning message of “recording is impossible” for the image quality level 0 exemplified in FIG. 12 is displayed on a standby screen. If the image quality level is 1, the process moves to step S408 and a warning message of “there is a possibility of sever deterioration of the recording image quality” for the image quality level 1 exemplified in FIG. 12 is displayed on a standby screen. However, in the case of image quality level 2, no warning message is displayed because recording can be performed without problem.

In step S409 following steps S407 and S408, whether the recording reservation is a reservation of M-FLO broadcasting or not is checked. In this case, when it is a reservation of M-FLO broadcasting, the process moves to step S410 and whether the image quality level of the reserved channel is equal to or less than 2 or not is checked. If it is not a reservation of M-FLO broadcasting (in other words, there is no recording reservation of 1seg broadcasting and M-FLO broadcasting), the process immediately moves to step S415 described hereinafter, and steps S415˜S419 are performed. With respect to the check in step S410, in the case of Yes (image quality level: 2, 1, 0), the process moves to step S411 and which of 0, 1 or 2 the image quality level of the reserved channel corresponds to is checked. In the case of No (image quality level: 3), the process immediately moves to step S415 described hereinafter and steps S415˜S419 are performed. When the image quality level is 0 according to the check in step S411, the process moves to step S412. Then a warning message of “recording is impossible” for the image quality level 0 exemplified in FIG. 12 is displayed on a standby screen. When the image quality level is 1, the process moves to step S413 and a warning message of “there is a possibility of sever deterioration of recording image quality” for the image quality level 1 exemplified in FIG. 12 is displayed. Then when the image quality level is 2, the process moves to step S414 and a warning message of “there is a possibility of deterioration of recording image quality” for the image quality level 2 exemplified in FIG. 12 is displayed. However, in the case of image quality level 3 (in the case of No in step S410), no warning message is displayed because recording can be performed without problem.

The display behavior of the above-mentioned warning message is described. When the user selects a desired program of channel from the EPG (Electronic Program Guide) displayed by the display unit 306 in order to make a recording reservation, the recording unit tries to record the selected program. However, in the case where the selected program may not be viewed (program of the image quality level 0 of 1seg broadcasting and M-FLO broadcasting), or in the case where the selected program can be viewed but has a possibility that the image quality is deteriorated (1seg broadcasting: program of the image quality level 1, M-FLO broadcasting: program of the image quality levels 1 and 2), the control unit controls so that the warning messages shown in FIG. 12 are displayed according to the image quality level of the program when the program is selected based on the reception state of the reception unit (1seg broadcasting: image quality levels 0˜1, M-FLO broadcasting: image quality levels 0˜2).

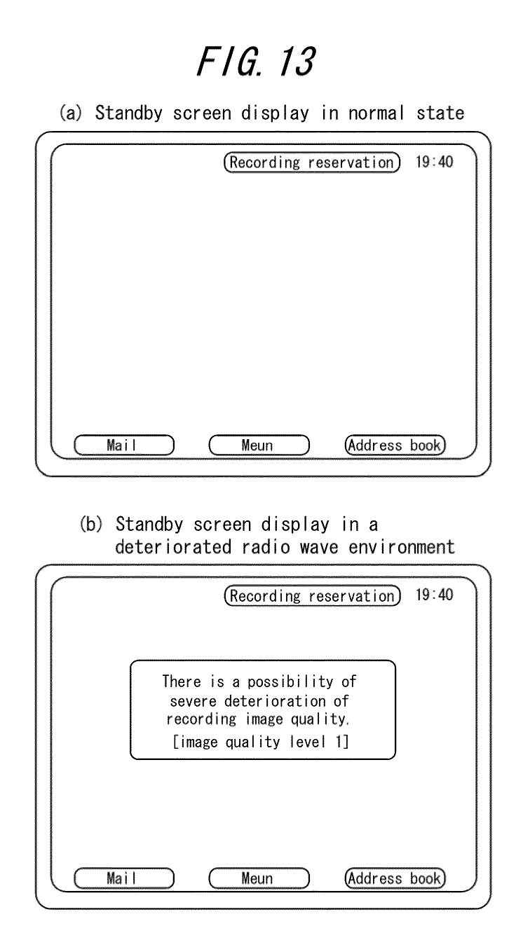

A display example of warning message actually displayed on a standby screen is shown in FIG. 13(b). Under a normal state (corresponding to the image quality level 2 of 1seg broadcasting and the image quality level 3 of M-FLO broadcasting), as shown in FIG. 13(a), only an indication showing that there is a recording reservation is displayed on a screen. However, when a broadcast receiving environment is deteriorated and the quality level becomes 1, for example, during recording reservation of 1seg broadcasting, a message of “there is a possibility of severe deterioration of recording image quality” as shown in FIG. 13(b) is displayed on a standby screen. In this case, when a reservation time is approaching, it is possible to take a measure such as warning is conveyed to the user by using a warning beep or vibration of a vibrator. In addition, “a warning message indicating that there is a recording reservation” may be displayed simultaneously when the differently-colored EPG display as shown in FIG. 10(a) is performed.

Thus, by performing the above mentioned differently-colored EPG display and display of warning message, when a recording reservation is made, it is possible, before a recording is actually started, to notify the user of possibility that the recording of the program of the channel that was reserved for recording becomes impossible or that the image quality of the recording may be deteriorated due to deterioration of the receiving environment even if the recording is possible. Therefore, unforeseen circumstances such as a recording of a program of a channel that was reserved for recording becomes impossible due to deterioration of a receiving environment can be prevented from occurring. Thus the user convenience is improved. In addition, when the user makes a recording reservation, by allowing a selection of a channel that cannot be viewed, it is possible to deal with the situation where the channel that cannot be viewed at present moment can be recorded when viewing of the channel becomes possible in the future. Thus the user convenience is improved.

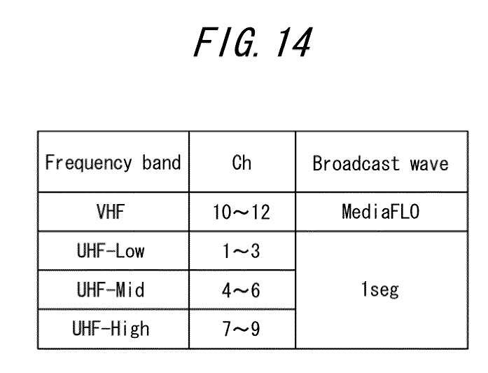

Further, with respect to the program guide display apparatus of the present invention, when a reception level (RSSI and C/N) of a 1seg broadcast signal is measured, the 1seg reception level acquisition unit 205 may measure the reception level by using a signal before demodulation. In addition, in the case where the image quality level table has already been acquired, for example, channels 1˜12 are classified as shown in FIG. 14. Then when channels 1˜3 correspond to the UHF-LOW frequency band of 1seg broadcasting, channels 4˜6 correspond to the UHF-Mid frequency band of 1seg broadcasting, channels 7˜9 correspond to the UHF-High frequency band of 1seg broadcasting and channels 10˜12 correspond to the VHF frequency band of M-FLO broadcasting, only a representative channel of each of the frequency bands (e.g. channel 2 for the UHF-LOW frequency band) may be scanned. Further, in the program guide display apparatus of the present invention, “a second reception unit for receiving a channel through a network” may be constituted by providing a wireless module for transmitting and receiving to and from a wireless network instead of either 1seg tuner module or M-FLO tuner module. In addition, “recording” is mentioned in the above-mentioned embodiment. However, the recording includes voice recording such as digital radio. In this case, the above-mentioned “recording” is interpreted as “voice recording”, and a recording unit is interpreted as a voice recording unit. Further, the voice recording unit includes a recording unit. Moreover, in the above-mentioned embodiment, the identification display corresponding to a reception state of a reception unit is indicated by using different colors. However, the identification display is not limited to this, but the displays that can be identified by the user are included. Further, the above-mentioned embodiment describes that the identification display is performed per channel. However, the identification display is not limited to per channel, but the identification display per program is also possible.

1. A program guide display apparatus, comprising:
a reception unit for receiving a program by selecting a selected channel;
a display unit for displaying a program guide that shows each program of each channel; and
a control unit for controlling so that an identification display corresponding to a reception state of the reception unit can be performed with respect to the program guide displayed by the display unit.

2. The program guide display apparatus according to claim 1, wherein the control unit controls so that the identification display corresponding to the reception state of the reception unit is performed per channel or per program.

3. The program guide display apparatus of claim 1, comprising a recording unit for recording, when the program is selected from the program guide displayed by the display unit, the selected program.

4. The program guide display apparatus of claim 1, wherein the control unit controls so that, based on a reception state of the reception unit, with respect to a program that cannot be viewed, selection of the program is cancelled.

5. The program guide display apparatus of claim 1, comprising a recording unit for recording, when a program is selected from the program guide displayed by the display unit, the selected program, and a reservation unit for making a recording reservation, when a program is selected from the program guide displayed by the display unit, of the selected program, wherein the control unit controls so that, based on a reception state of the reception unit, with respect to a program that may not be viewed or a program that can be viewed but has a possibility that an image quality is deteriorated, a warning message related to recording is displayed when the program is selected.

6. The program guide display apparatus of claim 1, wherein the reception unit comprises a first reception unit for receiving a program by selecting a channel of a first frequency band and a second reception unit for receiving a program by selecting a channel of a second frequency band, and the control unit controls so that the identification display corresponding to a reception state of each the first reception unit and the second reception unit is performed.

7. The program guide display apparatus of claim 1, wherein the control unit controls so that the identification display is performed based on an image quality corresponding to the reception state of the reception unit.

8. The program guide display apparatus of claim 3, wherein the control unit controls so that, based on a reception state of the reception unit, with respect to a program that cannot be viewed, selection of the program is cancelled.
